(19) United States
(12) Patent Application Publication
(10) Pub. No.: US 2026/0358276 A1
(43) Pub. Date: Nov. 12, 2026

(54) X-RAY FOCUSING AND WAVELENGTH SELECTION

(71) Applicant: NOVA MEASURING INSTRUMENTS INC., Fremont, CA (US)

(72) Inventors: Bruno W. SCHUELER, San Jose, CA (US); Gabor TOTH; Guorong V. ZHUANG, San Jose, CA (US); Gildardo DELGADO, Livermore, CA (US)

(73) Assignee: NOVA MEASURING INSTRUMENTS INC., Fremont, CA (US)

(21) Appl. No.: 19/486,944

(22) PCT Filed: May 23, 2023
(86) PCT No.: PCT/IB2024/055028

§ 371 Date: Nov. 23, 2025

Related U.S. Application Data
(60) Provisional application No. 63/503,957, filed on May 23, 2023.

(51) Int. Cl. G01N 23/2273

(52) U.S. Cl. CPC G01N 23/2273

(57) ABSTRACT

A system having local x-ray induced charge compensation capabilities, the system includes low energy electron (LEE) emission source configured to emit LEEs along one or more LEEs paths towards a region of a sample being illuminated by an x-ray beam, the LEEs impinge on the region and reduce a charging of the region due to the illumination by the x-ray beam, wherein each one of the one or more LEEs paths is oriented by a few degrees, to an optical axis of a photoelectron beam that is emitted from the region due the illumination by the x-ray beam.

### CROSS REFERENCE

This application claims priority from US provisional patent applications Ser. No. 63/503,957 filing date May 23, 2023—which is incorporated herein in its entirety.

### BACKGROUND OF THE INVENTION

In X-ray Photoemission spectroscopy (XPS), charging occurs on insulating sample surfaces. When energetic X-ray impinging on sample surface, photoelectrons will be emitted due to photoionization leaving core holes in the material. The so-called binding energy (B.E.) in XPS is characteristic to material properties and chemical environment. The emitted photoelectron kinetic energy from material is related to the B.E. and excitation photon energy hv: B.E.=hv−K.E. In conducting material, those core holes will be neutralized by connecting the material to ground.

However, these positively charged core holes will be trapped inside the insulating material, unable to be neutralized through grounding. Positive charge builds up on the insulating surface, which exerts an electrostatic potential on the outgoing photoelectrons, making those ejected p-e from the insulator have lower K.E. than that of conducting sample, thus leading to apparent high B.E.

During XPS data acquisition, charging of insulating sample is a function of exposure time, i.e., the longer the data acquisition time, the more positive charge buildup inside the sample. Therefore, the insulating sample charging is a dynamic process in the sense that supposition of multiple spectrums with different B.E. shift would exhibit not only B.E. shift but also peak broadening and distortion. Although algorithmic approach such as Dynamic Peak Tracking (DPT), Dynamic Range Tracking (DRT), Dynamic Peak Shifting (DPS) and Differential Charge Deconvolution (DCD) have long been largely successful to mitigate sample charge, these algorithmic approaches have their limitations and there is a need to provide more effective approaches to eliminate sample charging in state-of-the-art semiconductor wafers, such as 3D FIN, memory stack and virtual NAND memory units—as in the state-of-the-art event the grounding of the wafer (or otherwise biasing the wafer) via grounding pin in contact with the backside of the wafer—is insufficient to prevent the charging.

There is a growing need to provide a more flexible system.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a system and a sample;

FIGS. 2-8 illustrate examples of LEE emission sources;

FIG. 9 illustrates an example of a method; and

FIGS. 10-11 illustrates example of LEE emission sources and a magnetic lens.

### DETAILED DESCRIPTION OF THE DRAWINGS

There is provided a system having local x-ray induced charge compensation capabilities, the system includes a low energy electron (LEE) emission source configured to emit LEEs along one or more LEEs paths towards a region of a sample being illuminated by an x-ray beam, the LEEs impinge on the region and reduce a charging of the region due to the illumination by the x-ray beam, wherein each one of the one or more LEEs paths is oriented by a few degrees (for example between two and ten degrees), to an optical axis of a photoelectron beam that is emitted from the region due the illumination by the x-ray beam.

A low energy electron may have a kinetic energy between 10-100 eV—but may have a kinetic energy between 100 and 150 eV.

According to an embodiment, the system includes a magnetic lens that is configured to focus the LEEs onto an x-ray spot formed on the region of the sample, and to collimate the photoelectron beam.

According to an embodiment, the system includes a magnetic lens controller that is configured to change a strength of a magnetic collimating field formed by the magnetic lens in accordance with a kinetic energy of photoelectrons measured by a photoelectron analyzer located downstream to the LEE emission source. The analyzer outputs includes measurements related to different kinetic energies and the changing of the strength follows this changing.

According to an embodiment, the magnetic lens strength near the wafer surface may vary from some 100 Gauss to several kilo Gauss. The magnetic field strength diminishes away from the wafer surface toward the analyzer, charge neutralizing electrons with energies in the range of 30 to 100 eV entering the magnetic field from the opposite direction within a few degrees of the wafer normal will be focused on the center of a pole piece of the magnetic lens projected to the wafer surface with minor displacement. Changes in the magnetic field due to different photoelectrons to be collected will only result in a slight broadening of the region illuminated by the charge compensating electrons. The origin of the photoelectrons in turn coincides with the same region of the wafer surface immersed in a magnetic field to effectively collect and collimate the electrons to be collected and analyzed large angular range.

Depending on the impinging primary x-ray flux, the emitted photoelectron current will be in the vicinity of some hundred picoamperes. To provide effective charge neutralization, the required compensating electron beam current striking the emission region should be at least a factor 10 to 100 larger than the emitted PE flux from the wafer surface, i.e., at least a few to ~10 nA to the charged wafer site.

According to an embodiment, the system includes a first aperture formed between the LEE emission source and the sample. According to an embodiment, the first aperture is dedicated for passage control of the LEEs and/or the photoelectrons. According to an embodiment, the first aperture is formed in a multi-purpose element such as but not limited to a mirror used for deflecting laser radiation such as ultraviolet or visible light or infrared laser radiation.

According to an embodiment, the LEE emission source and the first aperture are shaped and positioned such as not to interact with the photoelectron beam. According to an embodiment the lack of interaction means that the LEE emission source and the first aperture do not prevent (or even partially prevent) the photoelectron beam from reaching the analyzer.

According to an embodiment, the LEEs form a LEEs spot on the region of the sample, wherein the LEEs spot at least partially overlaps the x-ray spot. According to an embodiment, the LEEs spot is large enough to include the x-ray spot.

According to an embodiment at least one of the following statement is applicable to the LEE emission source:
a. It includes an annular emission output region configured to emit LEEs along paths of different angles towards the region of the sample.
b. It includes an annular array of emitters configured to emit LEEs along paths of different angles towards the region of the sample.
c. It includes multiple emitters that are configured to emit LEEs along paths of different angles towards the region of the sample.
d. It includes a multi-channel plate assembly (MCP).
e. In includes an energy generator array.
f. It includes an energy generator array that includes micro channel plates that are biased to emit electrons.
g. It is a high vacuum compliant LEE emission source.
h. It is a LEE cold emission source. The LEE cold emission source is easier to operate and does not exhibit a lengthy stabilization and configuration period as a LEE thermal emission source.
i. It is a LEE thermal emission source. In this case the system includes a magnetic lens.
j. It includes a photocathode configured to convert laser light to LEEs.
k. It includes a filament coated with an electron emission enhancement coating, wherein the filament is made of Tungsten or Iridium.

According to an embodiment, the system includes a biasing unit for biasing the LEE emission source to emit and transport electrons having kinetic energy that ranges between 20 and 130 eV.

According to an embodiment, the system includes a photoelectron analyzer configured to analyze the photoelectron beam.

According to an embodiment, the system includes x-ray optics configured to generate the x-ray and to direct and focus the x-ray onto the region of the sample.

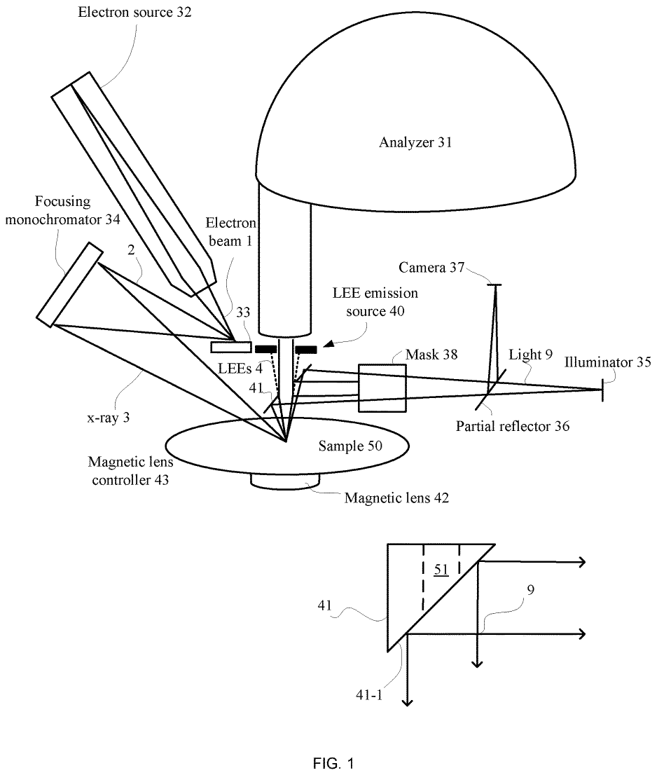

FIG. 1 illustrates an example of an XPS system that includes x-ray optics for generating x-ray 3 that impinges on sample 50, a laser light unit that may be used for illuminating the sample with light 9 and imaging the sample, LEE emission source 40 for emitting LEEs 4, and magnetic lens 42.

The x-ray optics include electron source 32 that illuminated anode 33 with an electron beam 1, causing the anode to emit an initial x-ray that impinges on focusing monochromator 34 which filters the initial x-ray to provide x-ray 3 that impinges on sample 50.

The light unit includes an illuminator 35 (such as a laser), a partial reflector 36 and a mask 38 for illuminating parts of mirror 41 (that parts differs from the first aperture formed in mirror 41), wherein the laser light from the mirror is directed toward the sample, illuminated the sample, and have returned light directed back to the mirror 41, directed to the laser light unit, and reflected by partial reflector 36 to camera 37.

In FIG. 1 the laser light unit and the LEE emission source 40 share mirror 41—light 9 is reflected from facet 41-1 while LEEs pass through aperture 51.

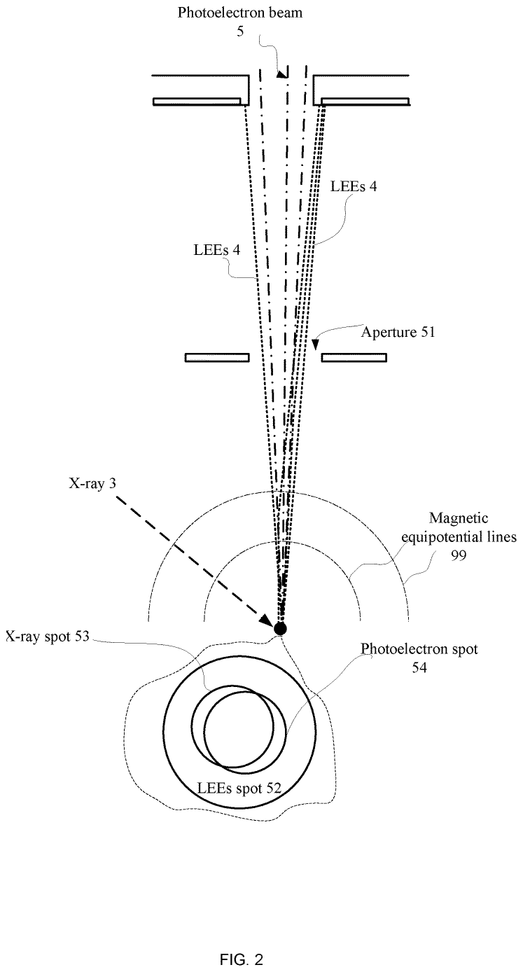

FIG. 2 illustrates an example of aperture 51, LEE emission source 40, LEEs 4 emitted towards sample and forming LEEs spot 52, x-ray 3 impinging on the sample and forming x-ray spot 53 and photoelectrons (forming photoelectron beam 5) emitted from the sample (from photoelectron spot 54). FIG. 2 also illustrates magnetic equipotential lines 99 generated by the magnetic lens (not shown).

According to an embodiment, the LEE emission source implements LEE cold emission sources. Among these cold emission sources are photocathodes, radiation illuminated Multichannel Plates (MCP), Electron Generate Array (EGA) and other LEE cold emission sources. All these LEE cold emission sources are applicable to charge compensation of semiconductor devices insulated from the conductive wafer substrate in X-ray Photoemission spectroscopy (XPS).

For a photocathode electron source, low energy electrons are generated from the illuminated target when the excitation source photon energy exceeds the photocathode target work function. Using energetic enough photons to overcome the energy barrier (EB), low energy photoelectrons will be ejected from the target and emitted to vacuum. The emitted photoelectron energy can be controlled by a negative bias voltage applied to the substrate. Thus, a low energy photoelectron beam with controlled energy can be generated. The emission current density is a function of material properties, such as quantum efficiency (Q.E.), work function, material density of states. Amongst suitable low work function photocathode materials which photoemitters with wavelengths at or above 260 nm—but not exclusively—are Indium, Yttrium, Magnesium, Magnesium alloys with Yttrium, Cesium Telluride, Barium, Samarium, etc. Not all listed materials will be acceptable in a Fab metrology environment, thus narrowing the applicable choice of materials. As a second consideration, emission stability of the photocathodes in non-ultra-high vacuum (UHV) equipment poses additional limitations to the material selection. In a UHV environment, the mentioned selection limitations thus do not necessarily apply.

According to an embodiment, the LEE cold emission source is a Multi-Channel Plate assembly (MCP) which is commonly used as electron detector.

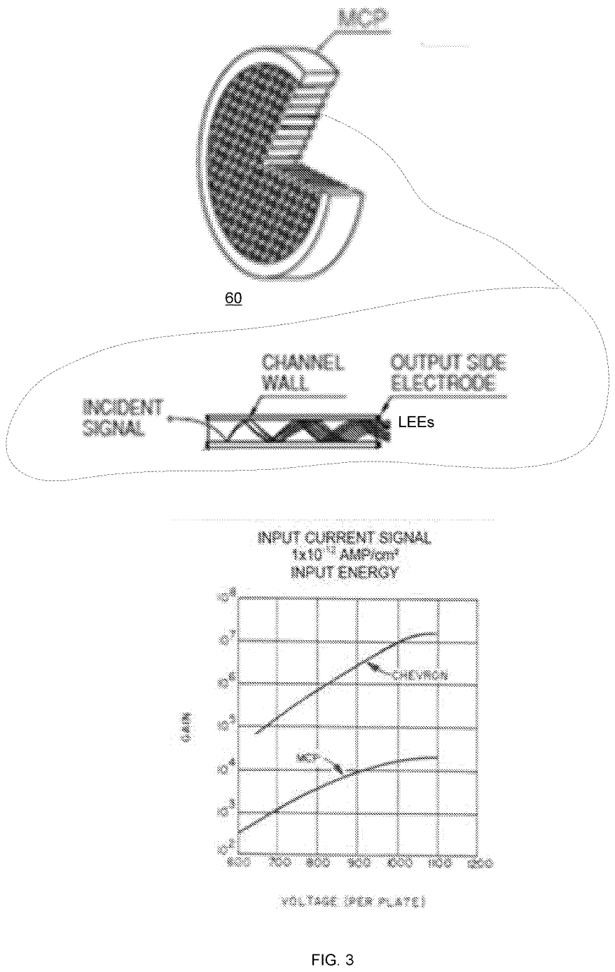

FIG. 3 illustrates an example of an LEE emission source that is an MCP 60 and illustrates the incident light that undergoes a conversion process by a channel of the MCP to output LEEs from output side electrode of the MCP. FIG. 3 also illustrates gain versus voltage curves of examples of MCPs.

The MCP includes an array of parallel or inclined channels (see FIG. 3—top section). A small incident electron signal at the entrance of each channel is amplified through a cascade process (see FIG. 3—middle section). The typical gain curve is shown in FIG. 3—bottom section. In this example, the incident signal is generated by photons instead of electrons, like an electron detector, except that the bias voltage of the detector is reversed to generate a controlled low-energy electron flux. By illuminating the MCP by ultraviolet (UV) radiation (UV, deep UV, or extreme UV), soft-Xray or Hard X-ray, photoelectrons will be generated from the entrance of MCP. These photoelectrons serve as input current signal, which in turn initiate the cascading of secondary electrons inside the MCP channel. The output secondary electrons from the MCP channels can be used as source for charge compensation. The output current is controlled by a) illumination optical power: the higher the optical power, the more photoelectrons as input current signal; b) bias voltage across entrance and exit of the MCP. The bottom section of figure illustrates that the higher the bias voltage, the higher the gain, and the two stack (Chevron) MCP gain is higher than that of single plate.

According to an embodiment the LEE cold emission source is an Energy Generator Array (EGA) which is another example of a LEE cold emission source. In contrast to an MCP, the EGA input current signal is originated from the spontaneous electron emitter from individual channel from programmed defect sites created in MCP. Thus, no external illumination source is required to generate electron beam current output at low electron energy (having kinetic energy between 10 and 150 Ev). The electron amplification mechanism and gain curves are like that of MCP as shown in FIG. 3—bottom section.

According to an embodiment the LEE cold emission source is high vacuum compliant, For example, Si nano tip emitters, Silicon Carbide, Bulk Molybdenum Spindt Field emission arrays, or Diamond nanotip emitter array could be arranged in a compact donut shape to emit electrons. Many of these emitters can be fabricated on the wafer level, operate at high emission field but (obviously) low applied voltages to the array. These structures can readily be diced to form factors suitable to comply with given geometries for implementation. Other technologies include high-density uniformly aligned silicon, Silicon Carbide, or carbon or other nanotip arrays or forest arrays.

In Fab metrology environment, particle-free operation of the emitter arrays is critical, limiting the acceptable selection of emitters somewhat for free-standing emitter arrays (such as forest a arrays). In general, on-chip emitter arrays would not cause particle generation issues.

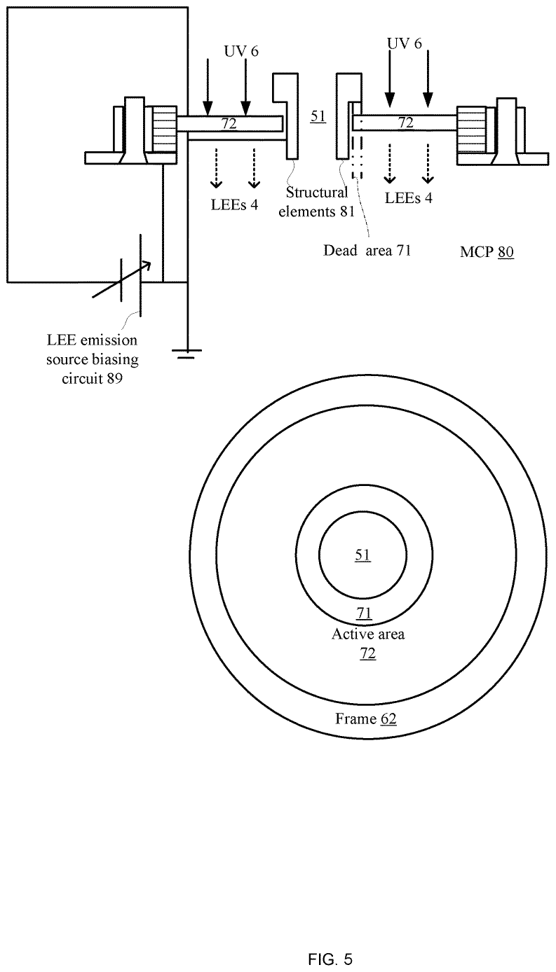

According to an embodiment the LEE cold emission source is a, a single or multiple thin hairpin or nanowire thermal field emission sources can be arranged as described in FIG. 5.

Hairpin or nanowire thermal field emission sources with an extraction grid to controlled extraction energy can be implemented. Ideal candidates, but not limited to, are W hairpins, LaB6 nanoneedle field-emission point electron sources.

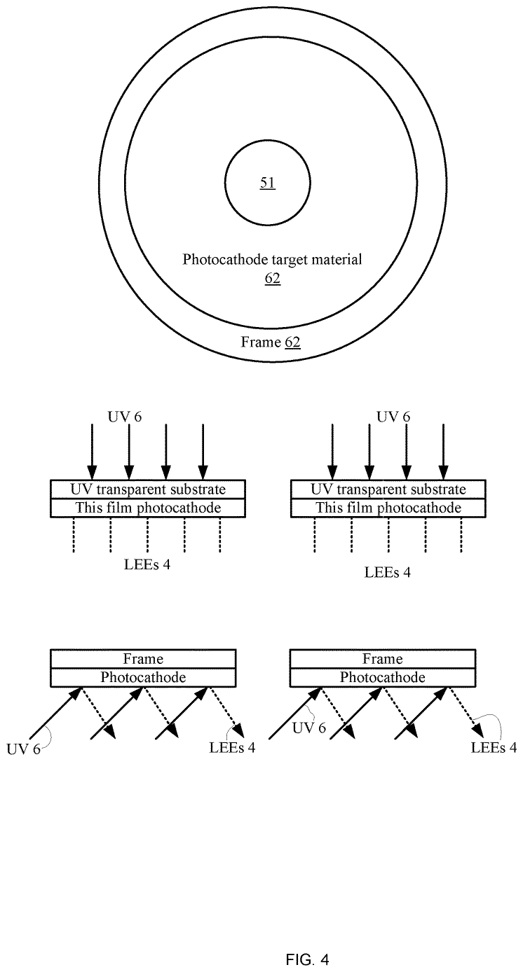

FIG. 4 is an example of a photocathode that includes an annular region that includes a photocathode target material for emitting LEEs 4 when illuminated with UV radiation 6, that surrounds aperture 51 and a frame 62 for supporting the photocathode.

The photocathode could operate in transmission mode (FIG. 4—middle section) or in a reflection mode (FIG. 4—bottom section).

In transmission mode, the photocathode target material is deposited as thin film on light transmission substrate. The electron emission may be generated by illumination of the photocathode through transmission substrate. In reflection (direct illumination) mode, the photocathode target itself serves as a source for electron generation. The thin photocathode material could also be deposited on a reflective substrate. In this operating mode, the UV illumination is directed onto photocathode target material itself. The photocathode target material could be a low work function metal, metal alloy. Since the emitted electron energies from the photocathodes are in the range of a few eV, an acceleration field will have to be applied to the substrate and care must be taken to shield the (XPS) photoelectrons from external electric fields due to the photocathode bias voltage. Other photocathode materials such as multi-alkali antimonide, nitrogen-incorporated ultra nanocrystalline diamond are high-efficiency photoemitters. However, the latter in general require extremely low vacuum levels.

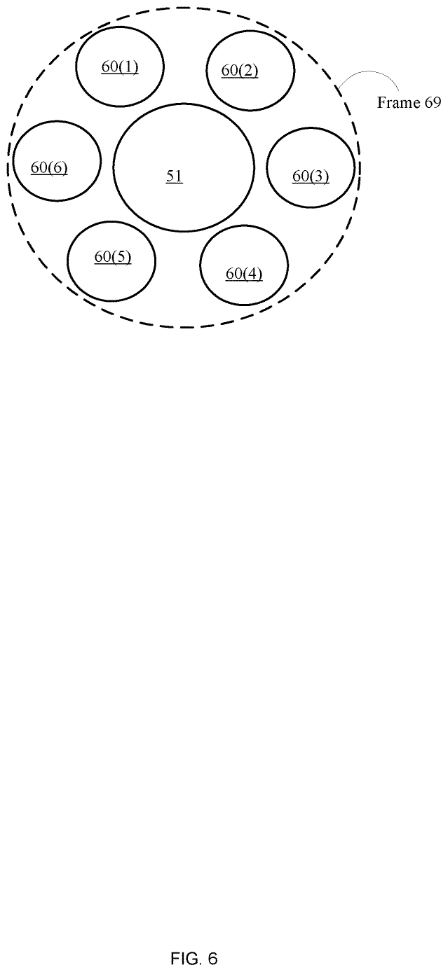

FIG. 5 illustrates an example of MCP 80 that includes a frame 62 for supporting the MCP active area 73, structural elements 81 for supporting the MCP active area 72 partially obscure the MCP active area 72 forming a dead area 71. The MCP 80 is biased by LEE emission source biasing circuit 89 that is configured to set the bias of the MCP. FIG. 6 illustrates the MCP as operating in a transmissive mode when converting UV radiation 6 to LEEs 4.

The MCP may be selected out of a single stage MCP, a double stack MCP (Cheveron) or a triple stack MCP (Z-stack).

FIG. 6 illustrates an example of an annular array of MCPs (60(1), 60(2), 60(3), 60(4), 60(5) and 60(6)) supported by a frame 69 having an annular shape that surrounds aperture 51.

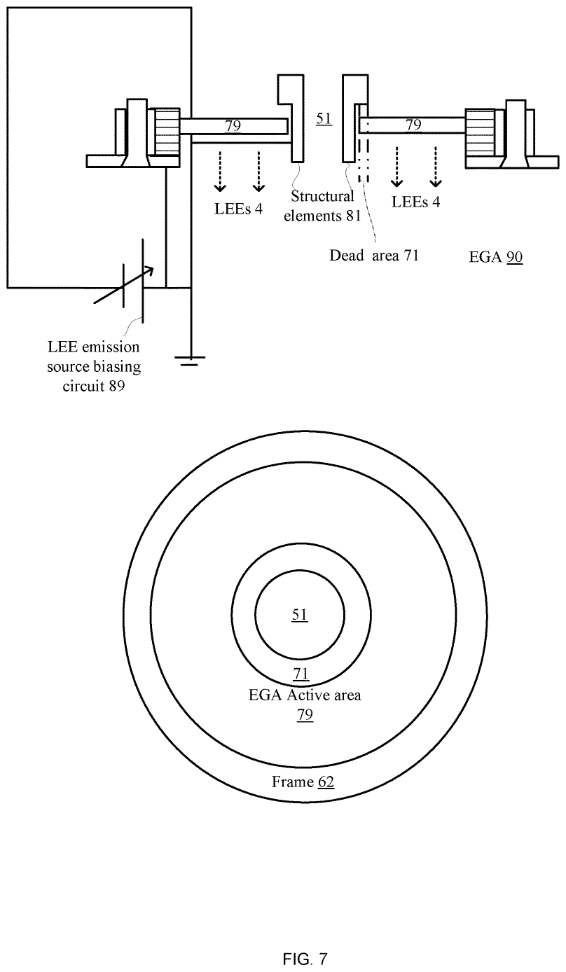

FIG. 7 illustrates an example of EGA 90 that includes a frame 62 for supporting the EGA active area 79, structural elements 81 for supporting the MCP active area 72 partially obscure the MCP active area 72 forming a dead area 71. The MCP 80 is biased by LEE emission source biasing circuit 89 that is configured to set the bias of the MCP. FIG. 7 illustrates the EGA as emitting LEEs 4.

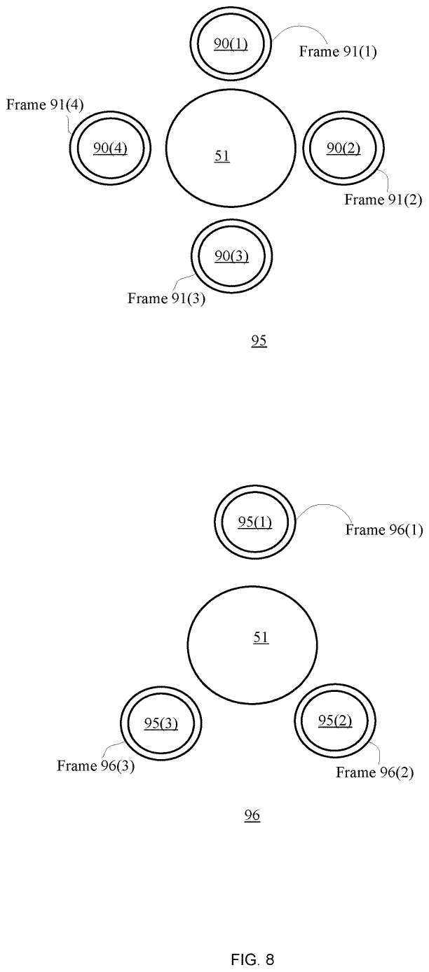

FIG. 8 illustrates a first example of an LEE emission source and a second example of an LEE emission source.

In the first example, the LEE emission source includes an array of EGAs (90(1), 90(2), 90(3) and 90(4)), each supported by a frame (91(1), 91(2), 91(3) and 91(4)) that form an annular array of EGAs that surround aperture 51.

According to an embodiment, one or more of the EGAs and/or one or more of the MCPs of FIG. 8 may be followed by an electrostatic Einzel lens.

In the second example, the LEE emission source includes an array of LEE thermal emission sources (95(1), 95(2) and 95(3)), each supported by a frame (96(1), 96(2), and 96(3)) that form an annular array of EGAs that surround aperture 51. In this case the system also include a magnetic lens for that is configured to direct and partially focus the LEEs onto an x-ray spot formed on the region of the sample, and to collimate the photoelectron beam. The usage of the magnetic lens prevents the LEEs from being deflected away from the x-ray spot.

According to an embodiment, the system exhibits at least one of the following:
a. Extended lifetime.
b. Operation without contamination of the sample.
c. Does not generate particles.
d. Being able to operate at a wide range of emission current controlled by light intensity and bias voltage for MCP.
e. Simpler implementation for EGA, no illumination source and optics is needed for the LEEs emission source.
f. Emission current is controlled by defect sites density and the voltage applied to the device.
g. Having a small footprint that allows the placing of the EGA close to the photoelectron path. For example—a thermal emission source with an electrostatic Einzel lens would be about 10 mm diameter and 15-20 mm long. The annular emission source would have a hole in the center, say ~12-14 mm diameter and a thickness of some 10 mm.
h. Focuses the photoelectron using a magnetic lens for charge compensation.
i. Using an electron lens to assist further shaping self-focus photoelectron beam, from thermal emitter source or cold emission source, to improve the charge compensation efficiency. The electron lens may be omitted from the system.

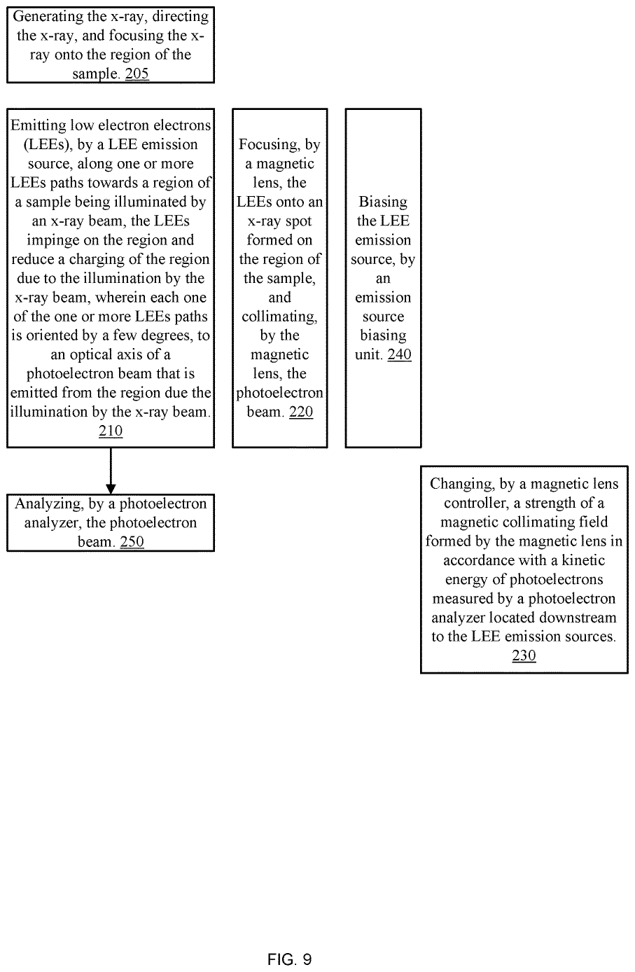

FIG. 9 illustrate an example of method 200 for local x-ray induced charge compensation.

According to an embodiment, method 200 includes step 210 of emitting low electron electrons (LEEs), by a LEE emission source, along one or more LEEs paths towards a region of a sample being illuminated by an x-ray beam, the LEEs impinge on the region and reduce a charging of the region due to the illumination by the x-ray beam, wherein each one of the one or more LEEs paths is oriented by a few degrees, to an optical axis of a photoelectron beam that is emitted from the region due the illumination by the x-ray beam.

According to am the method 200 also includes step 220 of focusing, by a magnetic lens, the LEEs onto an x-ray spot formed on the region of the sample, and collimating, by the magnetic lens, the photoelectron beam.

According to an embodiment, method 200 includes step 230 of changing, by a magnetic lens controller, a strength of a magnetic collimating field formed by the magnetic lens in accordance with a kinetic energy of photoelectrons measured by a photoelectron analyzer located downstream to the LEE emission source. The change occurs between iterations of step 210 and 220. The analyzer may output a spectrum that ranges across different values of kinetic energy and the magnetic field is changed during the scanning of the spectrum.

According to an embodiment, method 200 includes passing the LEEs through a first aperture formed between the LEE emission source and the sample.

According to an embodiment, method 200 includes preventing the LEE emission source and the first aperture from interacting with the photoelectron beam.

According to an embodiment, the LEEs form a LEEs spot on the region of the sample, wherein the LEEs spot at least partially overlaps the x-ray spot.

According to an embodiment, step 210 includes emitting the LEEs from an annular emission output region of the LEE emission source, so that the LEEs propagate along paths of different angles towards the region of the sample.

According to an embodiment, the LEE emission source is a LEE thermal emission source.

According to an embodiment, step 210 includes emitting the LEEs from an annular array of emitters of the LEE emission source, so that the LEEs propagate along paths of different angles towards the region of the sample.

According to an embodiment, step 210 includes emitting the LEEs from multiple emitters of the LEE emission source, so that the LEEs propagate along paths of different polar angles towards the region of the sample.

According to an embodiment, the LEE emission source includes a multi-channel plate assembly (MCP).

According to an embodiment, the LEE emission source includes an energy generator array.

According to an embodiment, the energy generator array includes micro channel plates that are biased to emit electrons.

According to an embodiment, the LEE emission source is high vacuum compliant LEE emission source.

According to an embodiment, the LEE emission source is a LEE cold emission source.

According to an embodiment, the LEE emission source includes a photocathode, wherein the method includes converting laser light by the photocathode to form the LEEs.

According to an embodiment, the LEE emission source includes a filament coated with an electron emission enhancement coating, wherein the filament is made of Tungsten or Iridium.

According to an embodiment, the method includes step 240 of biasing the LEE emission source, by an emission source biasing unit to cause the LEE emission source to emit and transport electrons having kinetic energy that ranges between 10 and 150 eV.

According to an embodiment, the method includes step 250 of analyzing, by a photoelectron analyzer, the photoelectron beam.

According to an embodiment, the method includes step 205 of receiving or generating the x-ray, directing the x-ray, and focusing the x-ray onto the region of the sample.

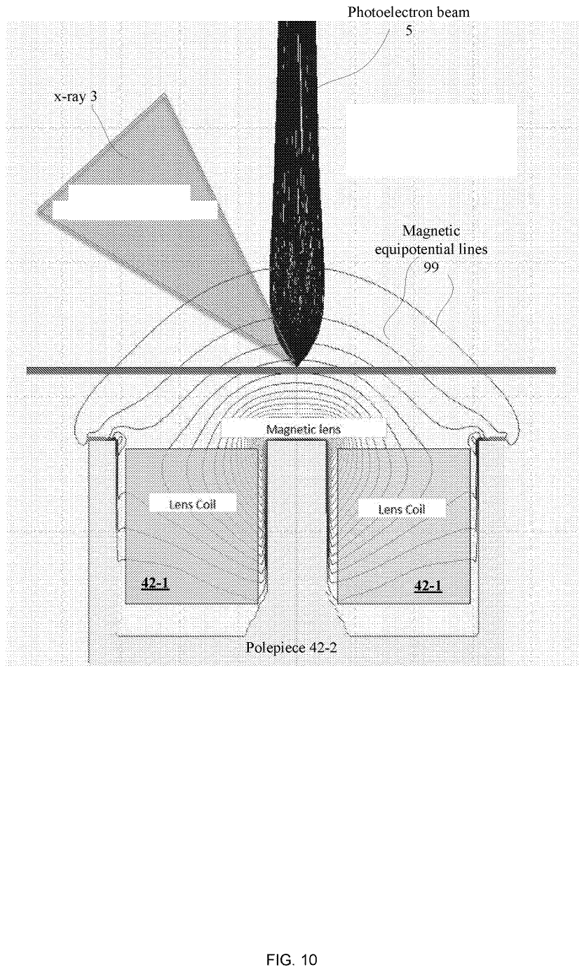

FIG. 10 illustrates an example of a cross section of a magnetic lens that include a polepiece 42-2 and an annular lens coil 42-1, equipotential magnetic lines, x-ray 3 and photoelectron beam 5.

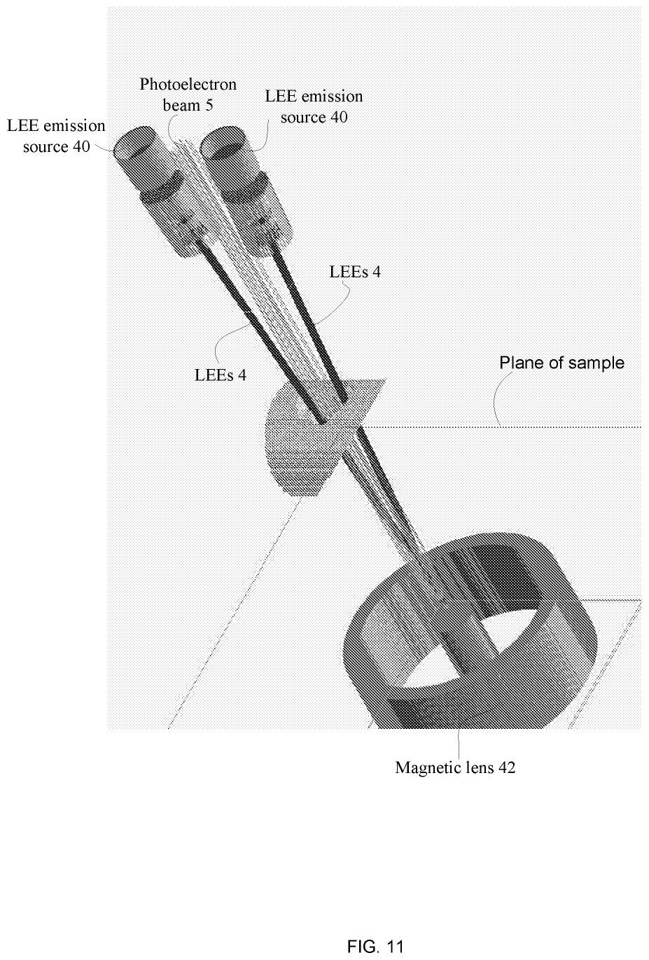

FIG. 11 illustrates an example of a pair of LEE emission sources 40, a photoelectron beam 5, LEEs 4 and magnetic lens 42. For simplicity of explanation the sample was not shown in FIG. 11—but it should be positioned within eh plane of the sample.

According to an embodiment, the LEE emission source includes an additional electrostatic focusing lens.

In the foregoing detailed description, numerous specific details are set forth to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method.

Any reference in the specification to a system should be applied mutatis mutandis to a method that may be executed by the system.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A system having local x-ray induced charge compensation capabilities, the system comprising:
low energy electron (LEE) emission source configured to emit LEEs along one or more LEEs paths towards a region of a sample being illuminated by an x-ray beam, the LEEs impinge on the region and reduce a charging of the region due to the illumination by the x-ray beam, wherein each one of the one or more LEEs paths is oriented by a few degrees, to an optical axis of a photoelectron beam that is emitted from the region due the illumination by the x-ray beam.

2. The system according to claim 1, further comprising a magnetic lens that is configured to guide and partially focus the LEEs onto an x-ray spot formed on the region of the sample, and to collimate the photoelectron beam.

3. The system according to claim 3, comprising a magnetic lens controller that is configured to change a strength of a magnetic collimating field formed by the magnetic lens in accordance with a kinetic energy of photoelectrons measured by a photoelectron analyzer located downstream to the LEE emission source.

4. The system according to claim 3, further comprising a first aperture formed between the LEE emission source and the sample.

5. The system according to claim 4, wherein the LEE emission source and the first aperture are shaped and positioned such as not to interact with the photoelectron beam.

6. (canceled)

7. The system according to claim 2, wherein the LEE emission source is a LEE thermal emission source.

8. The system according to claim 1, wherein the LEE emission source comprises an annular emission output region configured to emit LEEs along paths of different angles towards the region of the sample.

9. (canceled)

10. The system according to claim 1, wherein the LEE emission source comprises multiple emitters that are configured to emit LEEs along paths of different angles towards the region of the sample.

11. The system according to claim 1, wherein the LEE emission source comprises a multi-channel plate assembly (MCP).

12. The system according to claim 1, wherein the LEE emission source comprises an energy generator array.

13. The system according to claim 11, wherein the energy generator array comprises micro channel plates that are biased to emit electrons.

14-17. (canceled)

18. The system according to claim 1, comprising a biasing unit for biasing the LEE emission source to emit and transport electrons having kinetic energy that ranges between 10 and 150 eV.

19. (canceled)

20. The system according to claim 1, further comprising x-ray optics configured to generate the x-ray and to direct and focus the x-ray onto the region of the sample.

21. A method for local x-ray induced charge compensation, the method comprising:
emitting low electron electrons (LEEs), by a LEE emission source along one or more LEEs paths towards a region of a sample being illuminated by an x-ray beam, the LEEs impinge on the region and reduce a charging of the region due to the illumination by the x-ray beam, wherein each one of the one or more LEEs paths is oriented by a few degrees, to an optical axis of a photoelectron beam that is emitted from the region due the illumination by the x-ray beam.

22. The method according to claim 21, further comprising focusing, by a magnetic lens, the LEEs onto an x-ray spot formed on the region of the sample, and collimating, by the magnetic lens, the photoelectron beam.

23. The method according to claim 21, comprising changing, by a magnetic lens controller, a strength of a magnetic collimating field formed by the magnetic lens in accordance with a kinetic energy of photoelectrons measured by a photoelectron analyzer located downstream to the LEE emission source.

24. The method according to claim 23, further comprising passing the LEEs through a first aperture formed between the LEE emission source and the sample.

25. The method according to claim 24, further comprising preventing the LEE emission source and the first aperture from interacting with the photoelectron beam.

26. The method according to claim 22, wherein the LEEs form a LEEs spot on the region of the sample, wherein the LEEs spot at least partially overlaps the x-ray spot.

27-37. (canceled)

38. The method according to claim 21, comprising biasing the LEE emission source, by an emission source biasing unit to cause the LEE emission source to emit and transport electrons having kinetic energy that ranges between 10 and 150 eV.

39-41. (canceled)
